(19) United States
(12) Patent Application Publication
(10) Pub. No.: US 2003/0187757 A1
(43) Pub. Date: Oct. 2, 2003

(54) Targeted catalog information publication

(76) Inventor: Norman Ken Ouchi, San Jose, CA (US)

Correspondence Address: NORMAN KEN OUCHI, 20248 VIEWCREST CT, SAN JOSE, CA, 95120, US

(21) Appl. No.: 10/112,191

(22) Filed: Mar. 29, 2002

(51) Int. Cl. G06F 17/60

(52) U.S. Cl. 705/28

(57) ABSTRACT

This invention is related to electronic catalogs and changes in a buyer's catalog based on changes in a suppliers catalog. An item in a buyer's catalog has a part number (an item identifier) and information associated with the item. The item is provided by a supplier, which has a supplier catalog with a supplier part number for the item. The buyer's catalog has an Approved Manufacturer List that associates the item with the supplier part number. The item information in the buyer's catalog is modified when the item information in the supplier catalog is modified.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to electronic catalogs and publication of a change to an item in a supplier's catalog, which changes the item information in a buyer's internal catalog.

### BRIEF SUMMARY OF THE INVENTION

An organization uses an internal catalog to define and describe the components in the design and manufacture of their products. Each unique component is assigned an internal part number or item identifier that is used to identify the component in internal product documents such as Bills of Material and design drawings. Some of the components are purchased from suppliers and the suppliers provide component information in their supplier catalogs. Components are usually purchased using the supplier part number and the supplier part number is a second part number associated with the component in the internal catalog. From time to time, a supplier will change the values of properties for a component and the associated component information reflects the change. In the present invention, a change in the component information in the supplier catalog is electronically published to the internal catalog, which updates the internal catalog information for the component. The change in the component information can notify people in the organization to assure that impact of the change is assessed.

The supplier can use the catalog information publication to advertise new components. The buyer organization can then create a new component entry in the internal catalog, assign a new internal part number, and add the component supplier part number and information.

The buyer organization gains benefits through accurate and timely information in the internal catalog and reduced catalog maintenance cost. The suppliers gain benefits from reduction in publication cost, better customer service because of the use of the component information by customer organizations, and faster acceptance of new components into the market.

### BACKGROUND OF THE INVENTION

A catalog contains information about an item and an item identifier, a part number. An item supplier uses the catalog so customers can see what is offered by the supplier and order items using the associated part number. Catalogs are published and distributed to customers. Most people are familiar with mail order paper catalogs from companies like Lands End and Eddie Bauer. Catalogs have been published in electronic form as Compact Discs, e-mail, and Internet Web pages. Many companies provide the customer the ability to browse their catalogs and order items over the Internet using a Web browser. This is consumer on-line shopping. Web based catalogs have not been as successful when used to sell items within companies. Ariba and others have had some success with Web based catalogs for ordering office supplies and similar non-production items. Employees can order pencils and paper on-line.

However, the Web catalog and on-line ordering are not used for items used in the manufacture of products. Many products are assembled from components provided by component manufacturers and distributors. These suppliers publish information about their component products but much of the information is not used. The developers of a product development organization use an internal catalog that defines each component used in their products. Each component is assigned an internal part number that is used to identify the item in all design documents and in the Enterprise Planning System, Product Document System, etc. If the component is purchased from a supplier, the supplier part number from the supplier catalog is usually used to order the component. Thus, the item in the internal catalog has two part numbers: the internal part number and the supplier part number. The association of the internal part number and the supplier part number is called the Approved Manufacturer List, AML. While the AML may be in a separate database, consider the AML to be part of the internal catalog. Functions of the internal catalog may be within an organization's Enterprise Resource Planning system or Product Document Management system. Design tools use information provided by the suppliers and may have an internal library with information from the suppliers' catalogs. The prior art internal catalog may not be one system but a collection of functions in a set of systems. When a new component is added to the internal catalog or a supplier changes information about a component in the internal catalog, the supplier information must be translated into the format of the internal catalog to update the information. Since there are a large variety of systems that provides the internal catalog function, the suppliers cannot publish their information in a format that can be used by the internal catalogs of their customers. So, each supplier provides their information in their formats and the format for each supplier is different. Since the supplier information is not standardized, third party information aggregators translate supplier information into another format: the aggregator's format. In the prior art, each development organization must map the supplier or aggregator information into their internal catalog systems. Because of the level of effort to translate the information, only critical information is mapped and significant portions of the supplier information is not used. RosettaNet, an electronics industry consortium, has established standards and processes called Partner Interface Processes, PIPs, for a supplier to send descriptive information to a reseller so the reseller can sell the item using the reseller catalog. The receiving catalog must manually extract the item description from the message and enter the information into the receiving catalog. While the catalog change messages are standardized, the part number (item identifier) processes have not been defined. The part number processes are required for automating the catalog change process. FIG. 1 illustrates a supplier catalog that may be hard copy, a CD, or a Web site on the Internet. When there is a change in the supplier catalog, the customers of the supplier may be notified by mail, e-mail, notification on the Web site, or an Internet message like the RosettaNet Catalog PIP's or there may be no notification at all. The customers must manually extract the information that changed, access the internal catalog using the internal part number, and update the item information that changed.

Suppliers provide information on new products and changes to current products. The organization uses the internal catalog for all component information. Much of the new product information is only used when a design engineer is looking for it outside of the internal catalog. And, for the same reason, changes that improve the capabilities of a current product are not noticed. Suppliers stop production of a component and the component become obsolete. Suppliers provide ample lead-time to these changes and may provide alternatives. The e-mail and web site notifications are generally ignored and when component becomes obsolete, it is a surprise. Component changes lack a closed loop processes. The suppliers send the notifications but it is up to the customers to act on the notifications.

The AML is used to relate the internal part number to the supplier part number. The buyer maintains the relationship. In the electronic component market there is another mechanism using the Approved Vendor List, AVL, which is also used to purchase components. The AVL contains the name of the supplier who will send the correct part to an order using the seller's part number. To initialize the seller's tables, the buyer sends the supplier a description of the component and the buyer's internal part number and orders the item using the buyer's internal part number. The supplier selects the component from the supplier catalog that best fits the description, determines the supplier part number and maintains the relationship between the buyer's internal part number and the supplier's part number. In effect, the buyer controls the catalog that describes the item and the buyer must notify the supplier if there are changes to the item information. The AML and AVL processes change the part number of an item as it passes through the supply chain and item changes cannot be tracked using only the supplier part number. A closed loop component change process is needed to insure that all participants have been notified.

Suppliers spend a lot of money and time to create and distribute component information. Buying organizations want the information. The information is distributed in all forms: paper, CD, e-mail, web, etc. but there is a wide variety of supplier and buyer catalogs. Thus, the buyers must translate supplier information into their catalogs. Each supplier has their own format and buyers must translate from many sources. This is a many to many mapping problem, which results in custom development and adaptation with no market for commercial software.

### BRIEF DESCRIPTION OF DRAWINGS

FIG. 1 illustrates manual process to update an internal catalog from a supplier catalog.

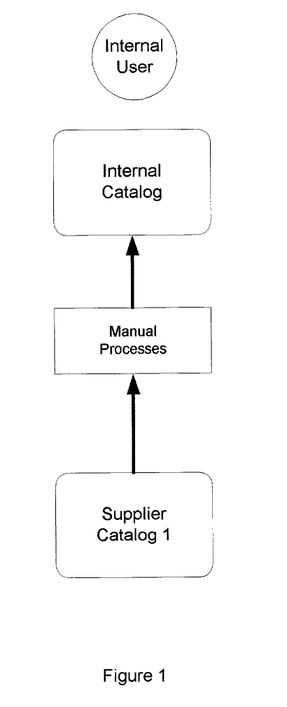

FIG. 2 illustrates the catalog update process where the supplier catalog sends a change message to change information in the internal catalog.

FIG. 3 illustrates the contents of the change message, the functions in the catalog update process, and the information in the internal catalog.

FIG. 4 illustrates a second supplier catalog sending a change message to update information for an item in the internal catalog.

### DESCRIPTION OF THE INVENTION

The electronics industry founded a consortium, RosettaNet, to define and implement standards for use of the Internet for business-to-business processes. RosettaNet has adopted a taxonomy, the structured classification of properties associated with a type of item, used to describe items used in the electronics industry. The taxonomy, called the RosettaNet Technical Dictionary (RNTD), provides an XML structure that can be used to describe an item by assigning values to each of the properties. RosettaNet has also defined an XML structure for a part number, the item identifier. A catalog can be created for a set of items by organizing the RNTD descriptions and their associated part numbers and provide a means to query for an item by description or by part number. The query by description returns the part number for the item and the query by part number returns the description of the item. RosettaNet has defined a standard for these two queries. Many electronic component suppliers are adopting the RNTD as the catalog structure for the items they provide. The RosettaNet standards provide a consistent, systematic means by which their customers can obtain real time, on-line information on items. But these catalogs are passive, designed to respond to queries.

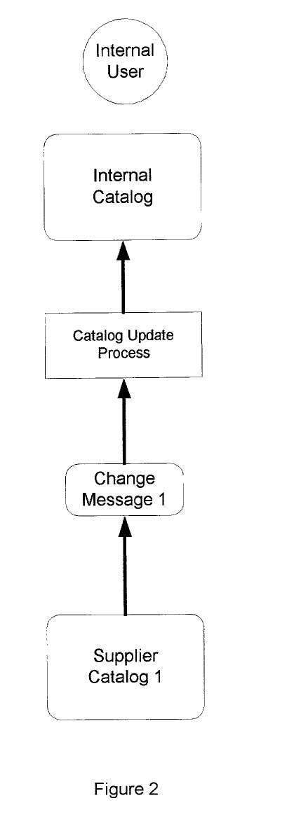

In the present invention, a catalog sends information about item changes to other catalogs. The change to item information has a format that combines the standard item description and the standard item part number. A catalog that receives an item change message queries the receiving catalog contents to determine if the part number exists. If the part number exists, then the item change information is used to update the receiving catalog contents. FIG. 2 illustrates a supplier catalog that changed information for an item and sends a change message 1 to a buyer's internal catalog. The buyer's catalog update process receives the change message 1 and updates the information for the item in the internal catalog.

It may not be desirable to update the item information without notification. The change message can initiate a closed loop process to assure that people who need to be notified of the change is notified. Once the notification process has completed, the catalog information is updated.

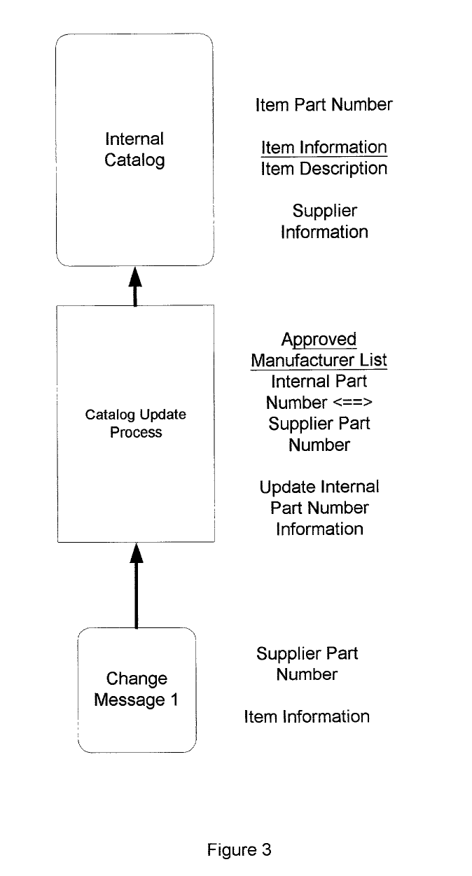

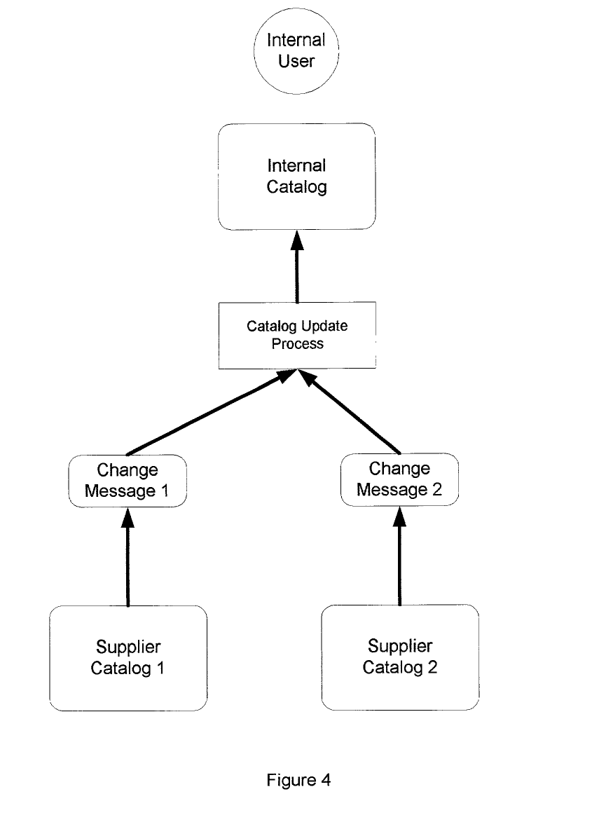

In most cases, the receiving catalog is the internal catalog of a development organization and the part numbers for the items are the internal part numbers of the organization. To receive updates from a supplier catalog, the internal catalog must also associate the supplier part number to the item. The Approved Manufacture List, AML, provides the cross-reference of internal catalog part number to supplier part number. When an internal catalog receives an item change message, the part number in the message is matched with the supplier part number in the AML. This provides the internal part number of the item and is used to access the item description. The item description can then be updated using the information from the item change message. The AML for an item may indicate that a second supplier is an acceptable supplier of an item and the second supplier part number is also in the AML. An item change notification from the second supplier can also update the item information. The AML may be extended to any number of suppliers. Note that many of the changes in the item information do not change the properties of the item itself but changes information such as item availability or similar information. The internal catalog may structure the item information so that the description of the item is separate from auxiliary information that may be specific to a supplier. The supplier information may be organized by supplier so that a change by one suppler does not affect the information from a second supplier. The internal catalog can be implemented using the RNTD for a taxonomy matching the supplier taxonomy but this is not a requirement. An item in an internal catalog has an internal part number and an item description. If the item is purchased from a supplier, the item is associated with the supplier part number, a second part number. If the supplier catalog changes information for the item, the supplier catalog sends an item change message to the internal catalog. FIG. 3 illustrates the contents of the change message and the change process. The change message contains the supplier part number for the item and the new or changed information for the item. The catalog update process receives the change message and matches the supplier part number with the supplier part number in the internal catalog, the AML, determines the internal part number, and updates the item information in the internal catalog using the internal part number. FIG. 3 further illustrates the item information having an internal part number, an item description, and information specific to a supplier. A supplier can change the item description as well as information specific to a supplier. However, most of the changes are specific to a supplier. FIG. 4 illustrates a second supplier catalog that sends a change message 2 that is received by the catalog change process. The change message 2 includes the second catalog part number for the item, the catalog change process maps the second catalog part number using the AML to the internal part number and updates the item information in the internal catalog.

If the internal catalog does not keep the supplier part number, the item description in the change message may be used to identify the item for which the information changed. The item description is used to query the internal catalog to return the internal item part number. Once identified, the item information can be updated. There is some uncertainty in that the item description may have changed so that the item cannot be correctly identified. The use of the supplier part number is preferred because of the more accurate item identification.

The RosettaNet part number definition can identify a specific item or can specify a class of items, items that share common values for a set of properties but differ in value in other properties. The change message can contain a part number for a class of items where the change in information applies to all items in the class. The receiving catalog may carry the item class as part of the supplier part number to determine the items to which the change applies or may query the supplier catalog to determine the supplier part numbers in the class.

The change message can include a hyperlink or URL to the supplier's information. The item information in the internal catalog may include the hyperlink or URL to access additional information from the supplier catalog. The additional information can be updated simulation models, item diagrams, etc. information that is large and not usually stored in the internal catalog but accessed from the supplier's web site.

To be effective, the change messages should be sent to catalogs that contain items supplied by a supplier. An efficient mechanism is called “subscribe and publish” where a catalog would subscribe to a supplier catalog by sending the supplier catalog the address of the catalog. The supplier would send catalog change messages to the addresses that subscribed. A catalog can also ask that its address be removed from the subscription list. A distributor may stock items from a supplier and assign it a part number that is different from that of the supplier. A customer of the distributor uses the distributor's part number to purchase the item and has the distributor part number in the AML of the customer internal catalog. The distributor receives a change message from the supplier. The change message contains the supplier part number. The distributor updates the distributor catalog using the supplier part number to identify the item. The distributor modifies the supplier change message by changing the supplier part number to the distributor part number and sends the change message to the customer. The customer uses the distributor part number to update the item information in the customer internal catalog. The item change message can be propagated even when the item part number changes because of intermediaries in the supply chain.

In the AVL mode of item procurement, the buyer identifies the item using the buyer part number. The supplier is responsible for the translation of the buyer part number to supplier part number and the buyer controls the description of the item. The supplier is notified when the buyer changes the item information in the buyer catalog. The change message contains the buyer part number. The supplier can change item information. The change message contains the buyer part number. A supplier can have an item that is identified by buyer part number by a first buyer and by supplier part number by a second buyer. The change message to the first buyer would include the buyer part number and the change message to the second buyer would include the supplier part number. With use of the appropriate part number, the change message will work for both the AML mode and AVL mode of item identification.

The supplier can send a change message for an item that is not in the buyer catalog. The message can indicate that the item is new and the message is not an update but rather an addition to the catalog. The buyer catalog can accept the addition and assign the item a new buyer catalog part number or the buyer can ignore the message. The description of the item can be used by the buyer catalog to detect that the item already exists in the catalog, has a buyer part number, and that if the new item is accepted, that this adds the supplier to the AML but does not create a new part number. The supplier can send information for new items in a manner that makes it easy for buyers to add the supplier items to the buyer catalog. This may be more effective that the current means of announcing a new product by sending hard copy letters and brochures to long distribution lists.

The present invention enables a change in a supplier catalog to be reflected in a buyer's internal catalog in near real time. Suppliers can reduce the cost of publishing information. The information will be timely, targeted to buyers' catalogs, and will be used. Suppliers can bring new and changed components into market faster. Better information results in higher customer satisfaction.

Customers and the developers will have timely information in their internal catalogs using the internal part number. The changes can initiate closed loop processes to assure that the appropriate people are notified before the change goes into effect. More of the supplier information can be accessed from the internal catalog and used directly. The development tools can reference the internal catalog and need not reference directly from the suppliers' catalogs. This will reduce the part number mapping overhead and avoid synchronization problems when changes are made.

Participants in a supply chain can receive closed loop notification. The AML and AVL processes can be used to process the part number transformations for items that are assigned different part numbers as it passes through the supply chain. Fast and accurate changes can be made.

### DESCRIPTION OF A PREFERRED EMBODIMENT

The information modification processes are implemented as software programs written in Java, C++, Microsoft Visual Basic, or a number of programming languages. The programs may use a database for storing translation tables and other information. Database programs are available from Oracle, IBM, Microsoft, and many other providers. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet. The catalogs are implemented using a database to organize the information using the RNTD taxonomy or other taxonomy. The part number is the database key to the item information. The supplier changes the supplier catalog and an XML message with the supplier part number and change information is created using a program to extract the changed information from the suppler catalog database. The details of the program depend on the structure of the supplier catalog and the degree of automation desired. The function can be accomplished by using a manual cut and paste if needed. The RosettaNet standard for part number and item description can be used. The catalog change message is sent to the Internet address of a buyer's catalog and received by the catalog change process program. The Approved Manufacturer List is a database table that maps the internal part number to supplier part numbers where each supplier part number is a row in the table. The catalog change process program extracts the supplier part number from the change message and uses it to access the AML table to return the internal part number for the item. The catalog change program extracts the change information and uses the internal part number to access the catalog database to change the item information using the change information. The information in the internal catalog database now reflects the change in the supplier catalog database.

I claim:

1. A modification of catalog item information for an item in a first catalog with a first part number from the first catalog and a second part number from a second catalog when the item information is modified in the second catalog.

2. The modification of catalog item information of claim 1, wherein the first catalog and second catalog are connected to a network, the Internet or an intranet.

3. The modification of catalog item information of claim 1, wherein the modification initiates a change notification process in the first catalog.

4. The modification of catalog item information of claim 1, wherein the second catalog sends information for an item not in the first catalog to create a new item in the first catalog.

5. The modification of catalog item information of claim 1, wherein the first part number is a member of a class of items and the information for the class of items is modified in the second catalog.

6. The modification of catalog item information of claim 1, wherein the first catalog uses the first part number to initiate the modification of catalog item information for the item in a fourth catalog.

7. The modification of catalog item information of claim 1, wherein the item has a third part number from a third catalog and the information for the item in the first catalog is modified when the item information is modified in the third catalog.

8. The modification of catalog item information of claim 1, wherein the information for the modification is sent by the second catalog using a “subscribe and publish model” based on the first catalog subscribing to the second catalog.

9. The modification of catalog item information of claim 1, wherein the information modification includes the second part number from the second catalog.

10. The modification of catalog item information of claim 1, wherein the information modification includes the description of the item.

11. The catalog item information modification of claim 1, wherein the information modification includes the first part number from the first catalog.

12. The modification of catalog item information of claim 1, wherein the information modification includes a hyperlink or URL to information for the item in the second catalog.

13. An item catalog with information for an item with a part number from the item catalog and a second part number from a second catalog, where the item catalog receives a modification to the item information from the second catalog and the item information is modified in the item catalog.

14. The item catalog of claim 13 wherein the item has third part number from a third catalog and the item catalog receives a modification to the item information from the third catalog and the item information is modified.

15. The item catalog of claim 13 wherein the information modification is based on the second part number.

16. The item catalog of claim 13 wherein the information modification is based on the item description.

17. A catalog maintenance system, a first catalog containing information for an item where the item has a first part number from the first catalog and a second part number from a second catalog, and a second catalog containing information for the item where the item has the second part number from the second catalog, wherein the catalog maintenance system modifies the item information in the first catalog when the item information in the second catalog is modified.

18. The catalog maintenance system of claim 17 where the item in the first catalog has a third part number from a third catalog and the catalog maintenance system modifies the item information in the first catalog when the item information in the third catalog is modified.

19. The catalog maintenance system of claim 17 wherein the information modification is based on the second part number.

20. The catalog maintenance system of claim 17 wherein the information modification is based on the item description.
